(19) United States
(12) Patent Application Publication
(10) Pub. No.: US 2019/0009304 A1
(43) Pub. Date: Jan. 10, 2019

(54) MACHINE FOR MEASURING AND SORTING ASSEMBLY PARTS SUCH AS COUNTERSUNK-HEAD RIVETS

(71) Applicant: STELIA AEROSPACE, Rochefort (FR)

(72) Inventors: Antoine Voisin, Achiet Le Grand (FR); Amaud Deleu, Mericourt Sur Somme (FR); Philippe Baron, Calais (FR)

(21) Appl. No.: 16/060,898

(22) PCT Filed: Dec. 9, 2016
(86) PCT No.: PCT/FR2016/053304

§ 371 Date: Jun. 8, 2018

(30) Foreign Application Priority Data
Dec. 18, 2015 (FR) 1562882

(51) Int. Cl. B07C 5/10; G01B 11/24; G01B 11/08; G01B 11/26; B07C 5/36

(52) U.S. Cl. CPC B07C 5/10; G01B 11/24; B07C 2501/0009; G01B 11/26; B07C 5/36; G01B 11/08

(57) ABSTRACT

The invention relates to a machine for measuring and sorting rivets comprising: a vessel for feeding rivets to be sorted, a plurality of trays for receiving sorted rivets, a device for conveying rivets to be sorted, optical means for acquiring images of each rivet to be sorted, a unit for processing images configured to provide at least one measurement of at least one structural feature of each rivet to be sorted, means for distributing each rivet towards a receiving tray, selected as a function of at least one measurement of at least one structural feature of said part supplied by said processing unit, each receiving tray being associated with a predetermined range of values of at least one structural feature for sorting the rivets.

### TECHNICAL FIELD

The invention relates to machines for measuring and sorting assembly parts such as countersunk-head rivets, in particular intended for an aeronautic application.

### SUMMARY

There are numerous standards enabling to identify assembly parts, such as countersunk-head rivets, from at least one structural feature of the parts. For example, the standards known by the acronyms ASNA 2019, ASNA 2051 or EN6100 classify rivets according, in particular, to the diameter of their head. Thus, in the standard ASNA 2019, rivets referenced 40 all have a head of which the diameter is between 6.20 mm and 6.78 mm, whereas rivets referenced 48 all have a head of which the diameter is between 7.87 mm and 8.47 mm. As can be observed, according to this standard, in one same reference, the diameter of the heads can have a difference of around 0.5 mm.

Yet, for certain aeronautic application, a specific flush between the head of the rivet and the skin of the aeroplane is to be respected, both to meet the aerodynamic limitations and the aesthetic limitations. This flush cannot exceed, for certain applications, 0.13 mm.

Also, as can be observed, the flush tolerance is stricter than the tolerance on the diameter of the rivet heads. It is therefore difficult and very limiting in practice to respect the flush limitations for all rivets coming from the same reference class. In particular, during a manual drilling, operator must make countersinks on aeroplanes depending on the assembly parts that they have. In other words, they must adapt the drilling to the exact dimensions of the assembly part, and in particular, to the diameter thereof. This involves measuring the exact dimensions of the assembly part and consequently adapting the countersinking operation or assembling part without being concerned about the exact dimensions and then removing the parts for which are observed after assembly that they do not meet the flush criterion required by the manufacturer. Whichever the solution implemented, this takes a long time.

A solution to this technical problem would be to modify the existing standards. That being so, the technical limitations and specificities of the manufacturers often have a lead time on the standards bodies so this solution is not only difficult to implement, but in particular, it does not enable to quickly respond to the technical problem encountered.

The inventors have therefore thought to implement a sorting on the parts provided by the manufacturers to separate each reference class of the assembly parts into a plurality of more specific sub-classes enabling to directly respond to the flush limitations imposed by the manufacturers.

The invention aims to provide a machine for measuring and sorting assembly parts, such as countersunk-head rivets.

The invention aims, in particular, to provide a machine for measuring and sorting assembly parts which automatically enables to measure and sort parts according to the measurements taken.

The invention aims, in particular, to provide, in at least one embodiment, a machine for measuring and sorting assembly parts which enables to measure a plurality of structural features of the parts, and to sort the parts according to at least one of these structural features measured.

The invention also aims to provide, in at least one embodiment of the invention, a machine for measuring and sorting assembly parts which enables to remove all parts which do not meet the predetermined technical specificities.

The invention also aims to provide, in at least one embodiment, a machine for measuring and sorting which enables to measure and sort parts at a pace of around 3 parts per second.

To do this, the invention relates to a machine for measuring and sorting assembly parts, such as countersunk-head rivets, each one comprising a head and a shaft, said machine comprising:
a vessel for feeding rivets to be sorted,
a plurality of trays for receiving sorted rivets,
a device for conveying rivets to be sorted arranged between said feeding vessel and said receiving trays,
optical means for acquiring images of each part to be sorted conveyed by said conveying device,
a unit for processing images acquired by said optical means, said processing unit being configured to provide at least one measurement of at least one structural feature of each part to be sorted,
means for distributing each part towards a receiving tray selected from said plurality of trays as a function of at least one measurement of at least one structural feature of this part provided by said processing unit, referred to as structural sorting feature, each receiving tray being associated with a predetermined range of values of at least one structural sorting feature of said assembly parts.

A machine according to the invention therefore enables to measure each part to be sorted by determining at least one measurement of at least one structural feature of each part, and to sort each part according to this measurement. Each part is measured by acquiring at least one image of this part and by analysing this image by a unit for processing images. This unit for processing images is configured to determine the values of certain structural features of each part. For example, according to an embodiment, the processing unit is configured to provide a measurement of the total length of the part and/or a measurement of the diameter of the head of the part, and/or a measurement of the ovalisation of the head of the part, and/or a measurement of the diameter of the shaft of the part, etc.

A machine according to the invention further comprises a plurality of trays for receiving sorted parts, each tray being associated with a predetermined range of values of at least one structural feature for sorting parts. Thus, for example, the structural sorting feature is the diameter of the head of the parts. The sorting machine can thus distribute parts to be sorted in each receiving tray according to the diameter of the head of the parts. Thus, according to an embodiment, each tray is associated with a specific range of diameters and separate from the ranges of other trays, such that all assembly parts having a diameter measured within the range of values of a tray are automatically sent towards this receiving tray by the distribution means. In this case, the diameter of the head of the parts constitutes a structural sorting feature.

According to the invention, it is therefore possible to sort a plurality of assembly parts received from a supplier under one reference and one standard, given and defined by a predetermined range of values of one or more structural features of these parts and to refine this reference class by the distribution of parts of this reference into a plurality of sub-classes each defining a sub-range of the predetermined range of values given by the supplier.

Thus, for example in the case of the standard ANSA 2019 and for assembly parts such as rivets classified under the reference 48 according to this standard and which all have, according to this reference class, heads of diameter between 7.87 mm and 8.47 mm, the invention enables to sort these rivets and distribute them into 5 sub-classes for example, each sub-class having a maximum dispersion of 0.12 mm. Thus, the sorting machine can distribute rivets into 5 receiving trays, one tray associated with the range of values 7.87 mm to 7.99 mm, one tray associated with the range of values 7.99 mm to 8.11 mm, one tray associated with the range of values 8.11 mm to 8.23 mm, one tray associated with the range of values 8.23 mm to 8.35 mm, one tray associated with the range of values 8.35 mm to 8.47 mm, plus one tray designed specifically constituting a reject tray wherein parts of non-conform value (diameter lower than 7.87 mm and greater than 8.47 mm) are rejected.

Of course, the dispersion of each sub-class can be configured by the machine according to the invention such that it is possible to measure and sort assembly parts into as many sub-classes as necessary according to the specificities of the applications wherein these assembly parts must be used.

According to the invention, measuring the structural features of the assembly parts is done by the optical means for acquiring images associated with a unit for processing images acquired by the optical means for acquiring images. This enables a precise, quick and solid measurement of the different structural features of the parts. In addition, this enables simply to adapt the means for measuring different types of assembly parts by modifying the image processing program implemented by the unit for processing images, however without requiring a structural modification of the measuring and sorting machine.

Advantageously, a machine according to the invention comprises means for gripping parts conveyed by said conveyor, said gripping means being configured to be able to move the assembly parts between a position, referred to as part seizure position, wherein the parts are on said conveying device, and a position, referred to as shooting position, wherein the parts are fixed with respect to said optical means for acquiring images.

According to this variant, the machine comprises means for gripping the assembly parts configured to be able to enter the parts on the conveyor and take them towards the optical means for acquiring images to be able to take measurements on the parts to be sorted. This enables to move the optical means for acquiring images from the device for conveying parts.

According to a first variant of the invention, the gripping means are configured to be able to hold assembly parts still opposite the optical means for acquiring images. According to another variant, the gripping means are configured to be able to take the rivets towards the means for holding the assembly parts separate from the gripping means. Such holding means are, for example, formed of a four-jaw flange adapted to hold an assembly part still in view of acquiring images of this part by the optical means for acquiring images.

Advantageously and according to the invention, the optical means for acquiring images comprise:
at least one camera, referred to as ovalisation camera, configured to be able to acquire an image opposite the head of each assembly part,
at least one camera, referred to a profile camera, configured to be able to acquire a side image of each assembly part.

According to this advantageous variant, two types of images are acquired to each assembly part to be measured and sorted, an image opposite this part and a profile image of this part so as to be able to determine both the structural features opposite this part, and the profile structural features of this part.

Advantageously and according to the invention, an ovalisation camera is arranged in the axis of the shaft of a part to be measured, held by said gripping means, opposite the head, to be able to acquire an image opposite the head of this part and a profile camera is arranged perpendicularly to the axis of the shaft of the part, to be able to acquire a side image of this part.

Advantageously, a machine according to the invention comprises a plurality of sorting stations, each sorting station being formed by the gripping means, an ovalisation camera, a profile camera, and means for distributing parts towards said receiving trays.

A machine according to this variant enables to multiply the number of measurements and sorts per time unit. According to an advantageous variant, the machine comprises three sorting stations such that the machine can measure and sort three times more parts than a machine having one single sorting station, the measurement cycle time of each station being 1 second.

Advantageously and according to the invention, the processing unit is configured to be able to provide, for each part, at least one measurement of at least one structural feature of this part from the following measurements—preferably at least one measurement of each one of the following structural features of this part:
an ovalisation measurement of the head of this part from at least one image of this part acquired by an ovalisation camera,
a measurement of the size of a possible impact on the head of this part, from at least one image of this part acquired by an ovalisation camera,
a measurement of the diameter of the head of this part, from at least one image of this part acquired by an ovalisation camera,
a measurement of the perpendicularity between the head and the shaft of this part, from at least one image of this part acquired by a profile camera,
a measurement of the swinging cone of the head with respect to the shaft of this part, from at least one image of this part acquired by a profile camera,
a measurement of the diameter of the shaft of this part, from at least one image of this part acquired by a profile camera,
a measurement of the cone angle of the head of this part, from at least one image of this part acquired by a profile camera,
a measurement of a reference diameter at a predetermined distance with respect to the head of this part, from at least one image of this part acquired by a profile camera.

A machine according to this variant can therefore measure a large number of structural features of assembly parts to be sorted. Each structural feature measured can form a determining structural sorting feature towards which receiving tray the sorted parts are directed.

Advantageously, a machine according to the invention comprises at least one reject tray, towards which said distribution means reject each part of which at least one measurement of at least one structural feature provided by said processing unit is not within a predetermined range of values.

A sorting machine according to the invention enables to sort parts according to at least one structural sorting feature. The machine according to this variant further enables to test other structural features of the parts and to reject parts of which the structural features, referred to below as secondary features, are not within a predetermined range of values. These parts are rejected towards a reject tray.

For example, the machine can be configured to sort parts according to the diameter of the head of the parts such that the receiving trays of the machine receive parts according to the diameter of the head of the parts. The diameter of the head of the parts thus constitutes a structural sorting feature. That being so, the machine measures other structural features, like for example the ovalisation of the head, the cone angle, the diameter of the shaft, etc. These features are secondary features, which are not used to sort parts into a plurality of sub-classes, but which are however measured. The machine rejects towards a reject tray all the parts of which the secondary features do not correspond to predetermined ranges of values. For example, the machine can be configured to reject towards a reject tray, all the parts of which the ovalisation measured is greater than 0.1 mm and/or all the parts of which the cone angle is outside of the tolerance interval 99.5° to 100.5°, etc. Of course, the tested features and the indicated values are given only as a non-limitative example.

Advantageously, and according to the invention, the optical means further comprise a camera, referred to as input camera, arranged at the level of the conveyor, close to the vessel for feeding parts to be sorted, this input camera being configured to provide at least one image, referred to as input image, and said processing unit is configured to be able to provide, from at least one image of each part acquired by this input camera, a measurement of the total length of the part, a measurement of the diameter of the head of this part, and/or a measurement of the diameter of the shaft of this part.

According to this variant, each part is observed by an input camera and analysed by the processing unit before being conveyed towards the measuring and sorting means (formed from the optical means for acquiring images, the processing unit and the distribution means). This enables to carry out a preliminary sort on the part to reject all the parts of which certain specific structural features are rejected from predetermined ranges of values. The structural features measured upstream of the measuring and sorting means, are for example the total length of the part, the diameter of the head of the part and the diameter of the shaft of the part.

Advantageously, and according to this variant, said distribution means are configured to reject towards a reject tray, any part of which at least one measurement provided by said processing unit from an image from said input camera is not within at least one predetermined range of values.

According to this variant, each part of which one of the structural features determined by the association of the input camera and the processing unit, does not correspond to a predetermined range of values is directly sent towards a reject tray. This enables a pre-processing of the parts to be sorted and to remove a certain number of non-conform parts for the aimed application, like for example the removal of intruders if a foreign part is arranged at the input of the machine. This also enables to quickly remove all parts from a possible batch of parts which does not correspond to the reference that is looked for to be sorted.

It must be noted, that according to an advantageous variant, a reject tray is associated with the input camera and a reject tray is associated with each sorting station. Thus, the parts deemed non-conform by the input camera are directly rejected towards the reject tray associated with the input camera and the parts deemed non-conform after going through a sorting station are rejected towards a reject tray associated with the sorting station. The fact of having a reject tray specifically associated with the input camera enables, for example, to quickly collect in one same reject tray, all the parts of a batch which does not correspond to the reference that is looked for to be sorted. However, the parts of the reference, not removed by the input camera, but however not corresponding to the ranges of values that are looked for to be separated, will be rejected towards the reject tray of the sorting station.

Advantageously, and according to the invention, said assembly parts are countersunk-head rivets intended for an aeronautic application.

The invention also relates to a measuring and sorting machine, characterised in combination by all or part of the features mentioned above or below.

### BRIEF DESCRIPTION OF THE DRAWINGS

Other aims, features and advantages of the invention will appear upon reading the following description given only as a non-limitative example and which refers to the appended figures, wherein:

FIG. 1 is a schematic, perspective view of a measuring and sorting machine according to an embodiment of the invention,

FIG. 2 is a schematic, perspective view of a part of the machine in FIG. 1 enabling to best see the optical means for acquiring images of an assembly part to be sorted,

FIG. 3 is a schematic view of a rivet which could be sorted by a machine according to the invention,

FIGS. 4a to 4j are schematic views of different structural features of a rivet which could be measured by a measuring and sorting machine according to an embodiment of the invention.

### DETAILED DESCRIPTION

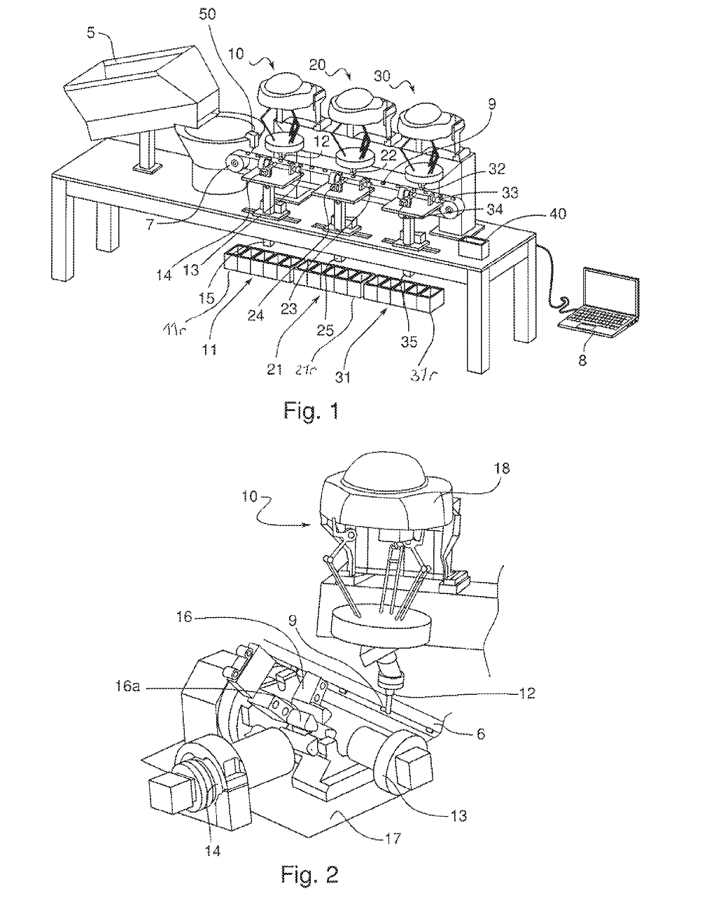

In the figures, the scales and proportions are not strictly respected, and this, for purposes of illustration and clarity. In the whole detailed description which follows in reference to the figures, except for any contrary information, each element of the sorting machine is defined such that it is arranged when the sorting machine is switched on. This arrangement is, in particular, represented in FIG. 1. In addition, identical, similar or comparable elements are referred to by the same references.

According to the invention and such as represented in FIG. 1, a machine for measuring and sorting assembly parts, such as countersunk-head rivets, comprises a vessel 5 for feeding parts to be sorted. In the whole detailed description which follows, the parts in question to be sorted are countersunk-head rivets. That being so, the invention also applies to other assembly parts. The condition is that the parts to be sorted comprise a head and a shaft connected to the head, the head extending perpendicularly to the shaft. This vessel 5 is fed with rivets manually by an operator.

A machine according to the invention also comprises a plurality of trays 11, 21, 31 for receiving rivets to be sorted.

The machine according to the invention also comprises a device for conveying rivets to be sorted arranged between the vessel 5 and the receiving trays.

According to the embodiment in the figures, the conveying device comprises a belt 6 for conveying rivets. This conveyor belt preferably has a V-shaped transverse straight section, so as to facilitate the centring of the rivets on the conveyor belt. This conveyor belt 6 is, for example, put into motion by a pinion 7 driven in rotation by an electric motor not represented in the figures.

According to a preferable embodiment of the invention, the vessel 5 for feeding rivets to be sorted is associated with a vibrating bowl enabling to move each rivet towards the conveyor belt 6. According to another embodiment, the vibrating bowl can be replaced by two slide hoppers.

A machine according to the embodiment in FIG. 1 also comprises three sorting stations 10, 20, 30. Each sorting station 10, 20, 30 respectively comprises a clamp 12, 22, 32 forming the means for gripping the rivets to be sorted, an ovalisation camera 13, 23, 33 configured to take an image opposite each rivet, a profile camera 14, 24, 34 configured to take a profile image of each rivet, and a funnel 15, 25, 35 forming the means for distributing rivets towards the trays 11, 21, 31 for receiving sorted rivets. In addition, each sorting station is associated with a reject tray. These reject trays of the sorting stations are referenced 11r, 21r and 31r in FIG. 1.

A machine according to the invention also comprises a unit 8 for processing images acquired by the cameras. The processing unit is configured to provide measurements of structural features of rivets to be sorted. Such a processing unit comprises, for example, a computer configured to implement one or more modules for processing images acquired by the cameras. A module means, a software element, a subset of a software program, which could be compiled separately, either for a separate use, or to be assembled with other modules of a program, or a material element, or a combination of a material element and a software sub-program. Such a material element can comprise an application-specific integrated circuit (better known under the acronym, ASIC) or a field-programmable gate array (better known under the acronym FPGA) or a digital signal processor (better known under the acronym DSP) or any equivalent material. Generally, a module is therefore an element (software and/or material) which enables to ensure a function. In the present case, the function ensured by a module of the unit for processing images is the measurement of one or more structural features of each rivet taken as an image by the means for acquiring images.

The unit 8 for processing images can be connected to the cameras by any types of known communication means, for example, by wireline means, such as wireline networks and/or wireless means such as wireless networks of the WIFI, Bluetooth, etc. type network. In the case of using wireline networks, these can equally be electrical networks, optical networks, magnetic networks and generally, any type of network enabling to transmit data between a camera for acquiring images and a unit for processing these digital images.

FIG. 2 is a detailed view of a sorting station of the machine according to the embodiment in FIG. 1. The sorting station is defined below in line with the sorting station referenced 10, being understood that the other sorting stations referenced 20, 30 preferably have a structure and a functioning identical to the sorting station referenced 10 defined below.

The sorting station 10 comprises a flange 16 further comprising four jaws 16a assembled on a support plate 17. The jaws 16a are configured to be able, on command, to surround a rivet brought between the jaws 16a by the clamp 12. The presence of four jaws 16a regularly distributed enables a good grip and immobilisation of each rivet during the acquisitions of images. The support plate 17 also supports the profile camera 14 and the ovalisation camera 13. The flange 16 is intended to receive each rivet to be measured. The clamp 12 forms the means for gripping the rivets between a position, referred to as rivet seizure position, wherein the clamp can seize a rivet on the conveyor belt 6 and a position, referred to as shooting position, wherein the rivet is held in the four-jaw flange 16.

According to the embodiment in the figures, the clamp 12 is movement-controlled by a robot 18. Such a robot 18 is, for example, a robot known under the commercial name, Fanuc M1. This robot is configured to be able to move the clamp 12 between the seizure position and the shooting position.

The sorting station 10 also comprises an ovalisation camera 13, configured to be able to acquire an image opposite the head of each rivet brought into the flange 16, and a profile camera 14 configured to be able to acquire a side image of each rivet brought into the flange 16. The sighting axes of the ovalisation camera 13 and profile camera 14 are therefore perpendicular.

For example, the ovalisation camera 13 is a CMOS 1/1.8 inch-type camera, having a resolution of 1600×1200. It is, for example, associated with a circular, low-angled blue LED lighting and a 102 mm macro lens. The profile camera 14 is, for example, a CMOS 1/1.8 inch-type camera, having a resolution of 1600×200 associated with a high-resolution telecentric lens.

In FIG. 2, a rivet 9 is gripped in the clamp 12 which is in the process of moving to bring the rivet 9 into the flange 16 such that the acquisitions of images by the ovalisation camera 13 and profile camera 14 can take place.

The sorting station 10 also comprises a funnel 15 for distributing each rivet towards the receiving trays 11. This funnel 15 comprises an upper opening (not seen in the figures) which leads to the support plate 17 and a lower, free opening arranged opposite the receiving trays 11. This funnel 15 is assembled pivoting with respect to the support plate 17 to be able to bring the lower opening opposite the receiving tray towards which the measured rivet must be delivered, given the measurements taken by the unit 8 for processing images. Once the measurement is taken, the funnel 15 is controlled to be able to move the lower end thereof towards the named receiving tray given the measurement. According to an embodiment, the clamp 12 seizes the rivet 9 in the flange 16 and releases it in the upper opening of the funnel. The rivet thus slides into the funnel 15 and emerges from it to fall into the named receiving tray given the measurements taken. According to another variant, the upper opening of the funnel 15 is stored under the flange 16 such that a release of the jaws 16a of the flange 16 directly leads to the fall of the rivet into the funnel 15.

According to the embodiment in the figures, the machine further comprises an input camera 50 arranged at the level of the inlet of the rivets 9 on the conveyor belt 6. The input camera is, for example, a camera associated with a 25 mm lens. This input camera 50 is configured to provide an input image of each rivet transmitted to the processing unit 8. The processing unit 8 is configured to be able to provide a measurement of the total length of the rivet, a measurement of the diameter of the head of the rivet, and/or a measurement of the diameter of the shaft of the rivet. If either of these measurements (of which the measuring principle is defined below) is non-conform, the rivet is not seized by the clamp 12 and is rejected towards the reject tray 40 without going through the sorting stations.

The reject tray 40 is arranged at the end of the conveyor. This reject tray 40 is intended to received non-conform rivets 9 detected by the input camera 50. According to the embodiment in the figures, the reject tray 40 is arranged at the end of the conveyor belt 6 such that if a rivet 9 is considered as non-conform with respect to the program selected by the processing unit 8, the clamp 12 of the sorting station does not take the rivet on the conveyor belt 6, which will naturally drive the rivet towards the reject tray 40. This tray being stored under the conveyor belt, the non-conform rivet will fall through gravity into the reject tray 40.

The machine also comprises a reject tray 11r, 21r, 31r associated with each sorting station. These reject trays 11r, 21r, 31r are intended to receive the rivets considered as non-conform, but after going through the sorting station, in other words, that these trays will receive the rivets for which at least one measurement of at least one structural feature provided by the processing unit 8 is not within a predetermined range of values.

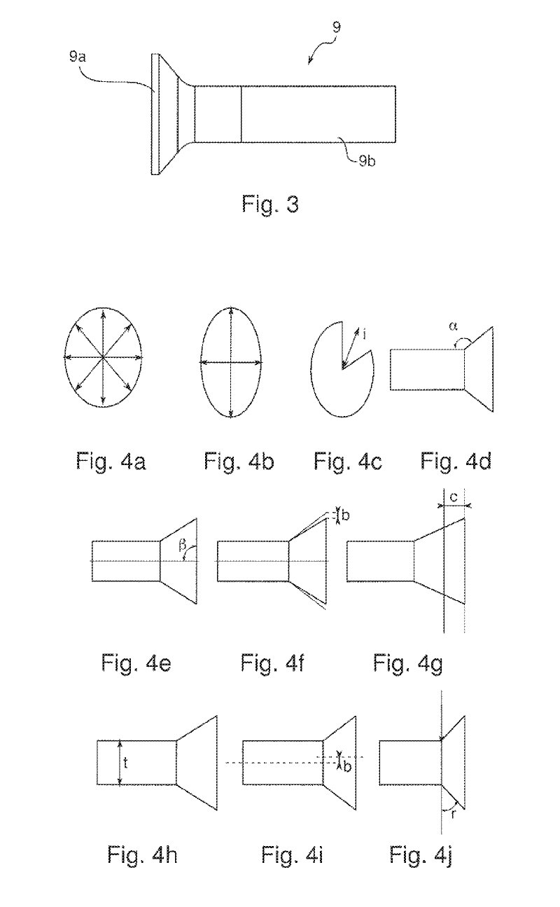

An example of a rivet which could be measured and sorted by a machine according to the invention is represented in FIG. 3. This rivet 9 comprises a head 9a and a shaft 9b. According to an embodiment of the invention, the processing unit 8 is configured to be able to measure the structural features of a rivet 9 schematically represented in FIGS. 4a to 4i.

FIG. 4a illustrates a measurement of an average diameter of the head 9a of a rivet 9 from a front image of the head acquired by the ovalisation camera 13 or from an input image acquired by the input camera 50. This measurement is taken by calculating an average diameter of the head from the measurement of a plurality of diameters of the head. If the diameter does not fall within a predetermined range of values, then the rivet 9 is considered as non-conform and is rejected towards the reject tray 40 if it has been detected by the input camera 50 upstream or towards the reject tray 11r associated with the sorting station 10 if it has been detected by the ovalisation camera 13 situated downstream.

FIG. 4b illustrates a measurement of the ovalisation of the head 9a of a rivet 9 from a front image of the head acquired by the ovalisation camera 13. This measurement is taken by calculating the difference between the maximum diameter measured and the minimum diameter measured. If the difference is greater than a predetermined threshold, then the rivet 9 is considered as non-conform and is rejected towards the reject tray 11r of the sorting station 10.

FIG. 4c illustrates a measurement of an impact on the head 9a of a rivet 9 from a front image of the head acquired by the ovalisation camera 13. This measurement is taken by measuring the radial dimension i of an impact, in other words, by measuring the radial dimension from a break in continuity of the periphery of the head. If the distance i measured is greater than a predetermined threshold, then the rivet 9 is considered as non-conform and is rejected towards the reject tray 11r of the sorting station 10.

FIG. 4d illustrates a measurement of the cone angle of the head 9a of a rivet 9 from a side image of the rivet 9 acquired by the profile camera 14. This measurement is taken by determining the angle α between the shaft 9b and the head 9b such as represented in FIG. 4d. If the angle does not fall within a predetermined range of values, then the rivet 9 is considered as non-conform and is rejected towards the reject tray 11r of the sorting station 10.

FIG. 4e illustrates a measurement of perpendicularity between the head 9a and the shaft 9b of a rivet 9 from a profile image of the rivet 9 acquired by the profile camera 14. This measurement is taken by determining the angle θ between the shaft 9b and the head 9a such as represented in FIG. 4e. If the angle has a predetermined variation with respect to an angle at 90°, then the rivet 9 is considered as non-conform and is rejected towards the reject tray 11r of the sorting station 10.

FIG. 4f illustrates a measurement of a swing of the cone of the head 9a with the shaft 9b of a rivet 9 from a profile image of the rivet 9 acquired by the profile camera 14. If the axis of revolution generated by measuring the cone does not fall into a cylinder of predetermined diameter (for example, 0.1 mm) around the axis generated by the shaft, the rivet 9 is considered as non-conform and is rejected towards the reject tray 11r of the sorting station 10.

FIG. 4g illustrated a measurement of the distance between a reference diameter of the head and the end of the head 9a of the rivet 9, from a profile image of the rivet 9 associated with the profile camera 14. This measurement is taken by determining the position of the reference diameter and the measurement of the distance c between the position of this reference diameter and the end of the head 9a. If this distance deviates from a predetermined range of values, the rivet 9 is considered as non-conform and is rejected towards the reject tray 11r of the sorting station 10.

FIG. 4h illustrates a measurement of the diameter of the shaft 9b of the rivet 9, from a profile image of the rivet 9 acquired by the profile camera 14 of from an input image acquired by the input camera 50. This measurement is taken by determining the diameter t of the shaft 9b of the rivet 9. If this diameter t deviates from a predetermined range of values, the rivet 9 is considered as non-conform and is rejected towards the reject tray 40 if it has been detected by the input camera 50 upstream or towards the reject tray 11r of the sorting station 10 if it has been detected by the ovalisation camera 13 situated downstream.

FIG. 4i illustrates a measurement of the concentricity of the shaft 9b with respect to the head 9a of the rivet 9, from a profile image of the rivet 9 acquired by the profile camera 14. If the axis of revolution generated by the measurement of the head does not fall into a cylinder of predetermined diameter (for example, 0.1 mm) around the axis generated by the shaft, the rivet 9 is considered as non-conform and is rejected towards the reject tray 11r of the sorting station 10.

FIG. 4j illustrates a measurement of the connecting radius r between the shaft 9b and the head 9a of the rivet 9, from a profile image of the rivet 9 acquired by the profile camera 14. If the connecting radius is greater than a predetermined value, the rivet 9 is considered as non-conform and is rejected towards the reject tray 11r of the sorting station 10.

### Example

In order to illustrate the principle of measuring and sorting a machine according to the invention, an example is given below for rivets known under the reference EN 6100-040.

The measured structure features are as follows:
diameter of the head,
ovalisation,
impact,
cone angle,
head/shaft perpendicularity,
cone swing with the shaft,
distance between a reference diameter and the end of the head,
diameter of the shaft,
concentricity,
connecting radius.

The table below specifies the values of the features leading to the rejection of the part towards the reject tray and the ranges of values associated with each receiving tray.

According to the embodiment below, the structural sorting feature is the average diameter of the head of the rivets. It is therefore from the measurements of this feature that the rivets are classified in the different receiving trays. The table below gives, for each measured structural feature, the ranges of values for which the rivet is considered as non-conform and the ranges of sorting values enabling to attribute each rivet to a receiving tray.

| | Features | | | |
|---|---|---|---|---|
| | Head | | | Cone |
| | diameter (d) | Ovalisation (o) | Impact (i) | angle (α) |
| | Calculation/measurement | | | |
| | | calculation o = | size | |
| | calculation d = | Δ(ømax- | measurement | Measurement |
| | average (ø)mm | ømin) (mm) | impact (mm) | α (°) |
| tray 1 | 6.60 < d < 6.7 | — | — | — |
| tray 2 | 6.71 < d < 6.81 | — | — | — |
| tray 3 | 6.82 < d < 6.92 | — | — | — |
| tray 4 | 6.93 < d < 7.03 | — | — | — |
| tray 5 | 7.04 < d < 7.16 | — | — | — |
| reject tray | d < 6.60 and | o > 0.1 mm | i > 0.05 mm | α < 99.5° and |
| | d > 7.16 mm | | | α > 100.5° |

| | Features | | | | |
|---|---|---|---|---|---|
| | | | Distance | | |
| | | | between | | Shaft |
| | Head/shaft | | øref and | Concentricity | diameter |
| | perpendicularity | Swing (b) | head (c) | (C) | (t) |
| | Calculation/measurement | | | | |
| | perpendicularity | | | | |
| | of axes | | | Head with | |
| | measurement | swing | distance | shaft | diameter |
| | (°) | measurement | measurement c | concentricity | measurement t |
| reference for | — | — | øref = d5 = | | — |
| calculation/ | | | 5.149 | | |
| measurement | | | | | |
| tray 1 | — | — | — | | — |
| tray 2 | — | — | — | | — |
| tray 3 | — | — | — | | — |
| tray 4 | — | — | — | | — |
| tray 5 | — | — | — | | — |
| reject trays | ⊥ < 0.08 | b > 0.08 | c < 0.757 and | C > 0.2 | t < 4.14 mm and |
| | | | c > 0.838 mm | | t > 4.153 mm |

Of course, these values are only given as an example for a rivet reference.

The configuration of the sorting machine can be done depending on needs. In particular, in the example given, the structural sorting feature is the average diameter of the rivet. According to other variants, another structural feature can be used as a structural sorting feature.

1. Machine for measuring and sorting assembly parts, such as countersunk-head rivets, each one comprising a head and a shaft, said machine comprising:
a vessel for feeding parts to be sorted;
a plurality of trays for receiving sorted parts;
a device for conveying parts to be sorted, arranged between said feeding vessel and said receiving trays;
optical means for acquiring images of each part to be sorted conveyed by said conveying device;
a unit for processing images acquired by said optical means, said processing unit being configured to provide at least one measurement of at least one structural feature of each part to be sorted;
means for distributing each part towards a receiving tray selected from said plurality of trays as a function of at least one measurement of at least one structural feature of this part provided by said processing unit, referred to as structural sorting feature, each receiving tray being associated with a predetermined range of values of at least one structural sorting feature of said assembly parts.

2. Machine according to claim 1, comprising means for gripping the parts conveyed by said conveyor, said gripping means being configured to be able to move the assembly parts between a position, referred to as part seizure position, wherein the parts are on said conveying device, and a position, referred to as shooting position, wherein the parts are fixed with respect to said optical means for acquiring images.

3. Machine according to claim 2, wherein the said optical means for acquiring images comprise:
at least one camera, referred to as ovalisation camera, configured to be able to acquire an image opposite the head of each assembly part;
at least one camera, referred to a profile camera, configured to be able to acquire a side image of each assembly part.

4. Machine according to claim 3, wherein at least one ovalisation camera and at least one profile camera are formed by one single and same camera that can be moved between a position wherein it is arranged in the axis of the shaft of the part to be measured held by said gripping means, opposite the head, to be able to acquire a front image of the head of this part, and a position wherein it is arranged perpendicularly to the axis of the shaft of this part, to be able to acquire a side image of this part.

5. Machine according to claim 3, comprising a plurality of sorting stations, each sorting station being formed by the gripping means, an ovalisation camera, a profile camera, and means for distributing the parts towards said receiving trays.

6. Machine according to claim 5, comprising three sorting stations.

7. Machine according to claim 3, wherein said processing unit is configured to be able to provide, for each part, at least one measurement of at least one structural feature of this part from the following measurements:
a measurement of ovalisation of the head of this part from at least one image of this part acquired by an ovalisation camera;
a measurement of the size of a possible impact on the head of this part, from at least one image of this part acquired by an ovalisation camera;
a measurement of the diameter of the head of this part, from at least one image of this part acquired by an ovalisation camera;
a measurement of the perpendicularity between the head and the shaft of this part, from at least one image of this part acquired by a profile camera;
a measurement of the swinging cone of the head with respect to the shaft of this part, from at least one image of this part acquired by a profile camera;
a measurement of the connecting radius of the head on the shaft of this part, from at least one image of this part acquired by a profile camera;
a measurement of the diameter of the shaft of this part, from at least one image of this part acquired by a profile camera;
a measurement of the cone angle of the head of this part, from at least one image of this part acquired by a profile camera;
a measurement of the distance along the head between a reference diameter and an end of the head of this part, from at least one image of this part acquired by a profile camera.

8. Machine according to claim 1, comprising at least one reject tray, towards which said distribution means reject each part of which at least one measurement of at least one structural feature provided by said processing unit is not within a predetermined range of values.

9. Machine according to claim 1, wherein said optical means further comprise a camera, referred to as input camera, arranged at the level of the conveying device, near the vessel for feeding parts to be sorted, this input camera being configured to provide at least one image, referred to as input image, of each part to be sorted, and in that said processing unit is configured to be able to provide, from at least one image of each part acquired by this input camera, a measurement of the total length of the part, a measurement of the diameter of the head of this part, and/or a measurement of the diameter of the shaft of this part.

10. Machine according to claim 9, wherein said distribution means are configured to reject towards a reject tray, any part of which at least one measurement provided by said processing unit from an image of said input camera is not within at least one predetermined range of values.

11. Machine according to claim 1, wherein each receiving tray is associated with a predetermined range of values of one single and same structural feature for sorting assembly parts.

12. Machine according to claim 11, wherein said structural sorting feature is the diameter of the head of the assembly parts.

13. Machine according to claim 1, wherein said assembly parts are countersunk-head rivets intended for an aeronautic application.
